(19) United States
(12) Patent Application Publication
(10) Pub. No.: US 2003/0130932 A1
(43) Pub. Date: Jul. 10, 2003

(54) Method of selling items using a computer and a communication network

(76) Inventor: Kwok D. Wong, Novi, MI (US)

Correspondence Address: Miller, Canfield, Paddock and Stone P.L.C., c/o Robert Kelley Roth, Suite 2500, 150 West Jefferson Ave, Detroit, MI, 48226, US

(21) Appl. No.: 10/337,803

(22) Filed: Jan. 7, 2003

Related U.S. Application Data
(60) Provisional application No. 60/346,692, filed on Jan. 8, 2002.

(51) Int. Cl. G06F 17/60

(52) U.S. Cl. 705/37

(57) ABSTRACT

A method of selling an item using a computer and a communications network comprises the steps of registering a seller of the item to be sold and registering a bidder with a facilitator, listing the item to be sold with the facilitator, and specifying an ask amount and a minimum amount, wherein a trading zone is defined as the range between the minimum amount and the ask amount. When the bidder makes a high bid at a price which equals or exceeds the ask amount, the high bid is accepted and processed for payment. When the bidder makes a low bid at a price which is less than the minimum amount, the facilitator automatically rejects the bidder's low bid. When the bidder makes a bid at a price which is greater than or equal to the minimum amount and less than the ask amount, the seller can choose to accept the bid, reject the bid, or make a counter-offer to the bid. The bidder can preferably make bids for all of the item to be sold, a portion of the item to be sold, or more than the item to be sold. The seller is capable of receiving essentially simultaneously bids corresponding to multiple bidders, and the facilitator may not reveal the bid of a separate bidder to any other bidder.

### RELATED APPLICATION

This application claims priority benefit of U.S. provisional patent application No. 60/346,692 filed on Jan. 8, 2002.

### FIELD OF THE INVENTION

This invention relates to a method of selling items, and, more particularly, to a method of selling items using a computer and a communication network, such as the internet.

### BACKGROUND OF THE INVENTION

With the advent of the internet, various e-commerce websites have been created to sell goods and services. Examples include www.ebay.com (“Ebay”), where sellers can list items and buyers can bid against one another for a limited period of time in a model similar to a standard auction format, where bidders compete against one another for a period of time until the auction closes, and the bidder with the highest bid at the close of the auction purchases the item. This bidding may be subject to a reserve, where the seller determines that no sale of the item will be made unless a minimum threshold price is met. Many websites have been created which generally follow this business model. These sites are advantageous in that geographically remote buyers and sellers who would heretofore not be aware of one another's existence can now get together to buy and sell practically any object which can be sold.

However, some problems have emerged with the EBAY auction model. In some cases, buyer's bids are either fraudulent, or the bidder can suffer “buyer's remorse” and chose not to honor the bid. This hurts both the seller in that the item does not get sold, and it hurts other legitimate bidders who did want to purchase the item. Further, unscrupulous sellers can, in some instances, use a “straw man” to artificially inflate the bid. This hurts legitimate buyers. In addition, the auction is typically open for bids for a limited period of time. In many cases much of the serious bidding only occurs near end of this limited period of time. Thus bidder can lose interest if he happens to be bidding at a time distant from the end of the period. Also, if the bidder is bidding near the end of the period, there is a possibility that the bidder's bid may be locked out. All of this can prevent legitimate bidders from purchasing an item that they want, and can hurt sellers in that legitimate bidders may not appear to bid on the item they are trying to sell. On top of these problems, there can also be problems with loose ends. That is, once the parties have agreed on a price of the item, the parties also may have to negotiate time, place, and manner of delivery of the item. This raises additional potential for deal failure.

Another site with a different business model is www.bargainandhaggle.com (“Bargain & Haggle”). At this website, a seller can list an item with a preferred price, and then potential buyers line up sequentially to bid on the item. Each bidder is not restricted by the preferred price. Each bidder is permitted up to three bids, to prevent the first bidder from monopolizing the seller's attention to the possible detriment of both the seller and other bidders. If the seller and the bidder have not reached agreement after three rounds of bidding, then the next bidder is given an opportunity to bid. The next bidder would also be able to see the highest bid of any previous bidder. The next bidder would be free to bid below any previous bids. This method, however, is inefficient, both for the seller and prospective bidders. Sellers do not get an opportunity to “play the field”, that is, to pit one bidder against another to get the best price for the item being sold. Prospective bidders further down in the queue may be waiting for nothing as the item gets sold before their turn to bid. Prospective bidders who see a long line for an item may get discouraged and not even get in line for bidding. These dynamics all tend to lessen demand for the item which can in turn result in a lower sale price for the seller. Moreover, the seller may have declined bid offers from one bidder who is higher in the line-up, only to arrive at a lesser deal with a subsequent bidder who does not complete the transaction with proper payment. The seller has tremendous opportunity cost and the previous bidder who was serious and qualified to complete the deal is without the item. Undue stress and pressure is put on the bidders because they only get a limited number of rounds to arrive at a deal with the seller. This stress and pressure may cause the bidder to bid higher at the time of bidding, but end up with the bidder reneging on the transaction during the payment process. As noted previously, “buyer's remorse” is inefficient for everyone, and can break down the confidence of the users of the site.

It would be desirable to have a method of selling items which reduces fraud, enhances the positions of both the seller and the buyer, and provides a more comfortable and familiar setting for purchase of an item.

### SUMMARY OF THE INVENTION

In accordance with a first aspect, a method of selling an item using a computer and a communications network is provided which comprises the steps of registering a seller of the item to be sold and registering a bidder with a facilitator, listing the item to be sold with the facilitator, and specifying an ask amount and a minimum amount. A trading zone is defined as the range between the minimum amount and the ask amount. When the bidder makes a high bid at a price which equals or exceeds the ask amount, the bidder's high bid is automatically accepted. When the bidder makes a low bid at a price which is less than the minimum amount, the facilitator automatically rejects the bidder's low bid. When the bidder makes a bid at a price which is greater than or equal to the minimum amount and less than the ask amount, the seller can choose to accept the bid, reject the bid, or make a counter-offer to the bid.

In accordance with another aspect, the seller is capable of receiving essentially simultaneously bids corresponding to multiple bidders, and the facilitator may not reveal the bid of a separate bidder to any other bidder. In accordance with another aspect, the bidder is only able to bid on the item to be sold upon providing payment information to the facilitator. In accordance with still another aspect, when the item can be split into a plurality or lot of items, the bidder is capable of bidding on merely a portion of the item.

From the foregoing disclosure and the following more detailed description of various preferred embodiments it will be apparent to those skilled in the art that the present invention provides a significant advance in the technology and art of methods of selling items. Particularly significant in this regard is the potential the invention affords for providing a high quality, low cost, efficient, easy to use, internet based method of selling items which reduces problems with fraud and enhances the transaction process. Additional features and advantages of various preferred embodiments will be better understood in view of the detailed description provided below.

### BRIEF DESCRIPTION OF THE DRAWINGS

FIG. 1 is a schematic flow chart showing the process of registration for a seller and listing the item to be sold with the facilitator in accordance with a preferred embodiment.

FIG. 2 is a flow chart showing the process of receiving a high bid in accordance with a preferred embodiment.

FIG. 3 is a flow chart showing the process of receiving a low bid in accordance with a preferred embodiment.

FIG. 4 is a flow chart showing the process of haggling over a bid until either acceptance or rejection is reached, in accordance with a preferred embodiment.

It should be understood that the appended drawings are not necessarily to scale, presenting a somewhat simplified representation of various preferred features illustrative of the basic principles of the invention. The specific features of the method of selling items as disclosed here, including, for example, the specific operating parameters of the facilitator, will be determined in part by the particular intended application and use environment. Certain features of the illustrated embodiments have been enlarged or distorted relative to others to facilitate visualization and clear understanding.

### DETAILED DESCRIPTION OF CERTAIN PREFERRED EMBODIMENTS

It will be apparent to those skilled in the art, that is, to those who have knowledge or experience in this area of technology, that many uses and design variations are possible for the method of selling items disclosed here. The following detailed discussion of various alternative and preferred features and embodiments will illustrate the general principles of the invention with reference to a method of selling an item where over the internet between remote sellers and buyers. Other embodiments suitable for other applications will be readily apparent to those skilled in the art given the benefit of this disclosure.

The method of selling an item uses a facilitator 10. Preferably the facilitator comprises a computer program using a networked website accessible by sellers 20 and buyers/bidders 30 so that they can be linked together. As a preliminary step in the method of selling an item, viewers of the website must become registered members with the facilitator 10 so that they will be identified as sellers 20 and bidders 30. Registration requires submission of at least identification information, and listing information. Identification information can comprise, for example, a name, an address, a phone number(s), an e-mail address(es), a social security number and/or driver's license number, etc. Identification information could also comprise optional data about the user's likes and preferences. Identification information could also comprise a shipping address and information about the agent that the item would be shipped to if a shipping agent is used. At least at the same time as bidding payment information must be provided. Submission of payment information may occur as part of registration with the facilitator, or may, for example, be requested by the facilitator prior to any bidder making a bid. Payment information can comprise, for example, a credit card number of a valid credit card account, an electronic checking service, etc. In certain preferred embodiments submission of payment information may not be necessary for individuals who only wish to list and sell items with the facilitator.

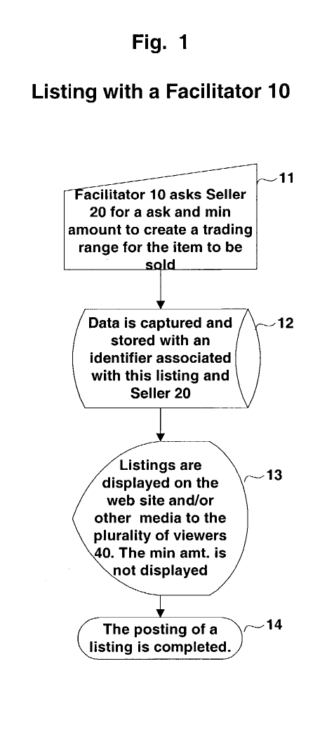

As shown in step 11 of FIG. 1, once a seller 20 is a registered member of the facilitator 10, the seller 20 can create a listing for an item to be sold. The seller would specify an ask amount and a minimum amount to sell the item, effectively creating a conditional offer to sell the item. The range between the minimum amount and the ask amount is called a trading range (or haggle range) and is described in greater detail below. In step 12, this data specified by the seller is captured and stored, and an identifier is created which is associated with this particular listing and this particular seller. In steps 13-14 all such listings are displayed on the website (and any other media) of the facilitator 10 so that it is visible to any viewer 40 who views the website whether they are registered members or not. In accordance with a highly advantageous feature, a seller 20 must be a registered member to list or bid on an item for sale, and all the items that are for sale are identified by the listing.

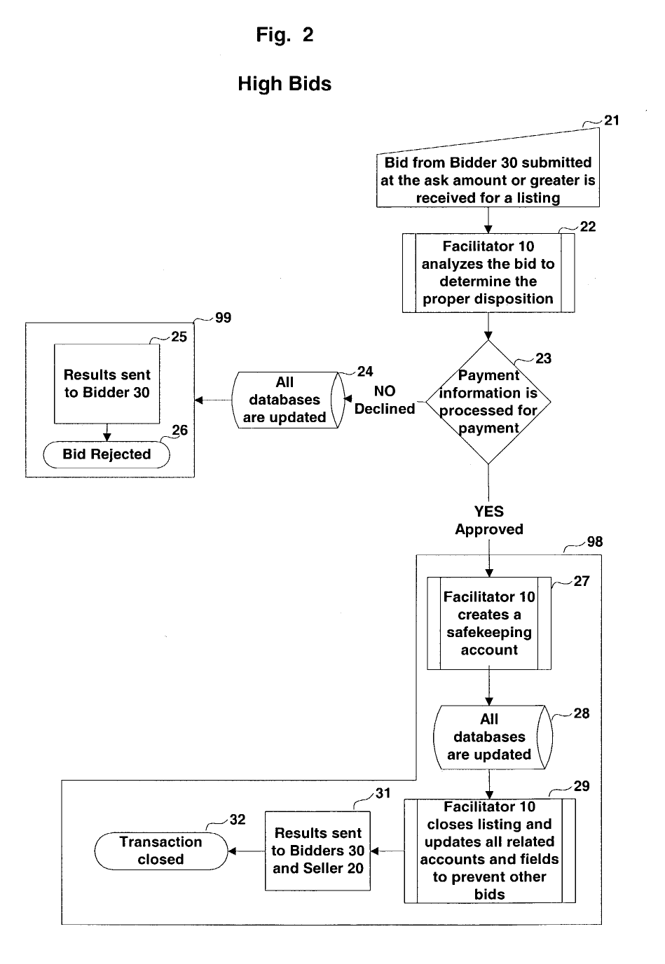

FIG. 2 shows what happens when a bidder 30 has entered a high bid for a listed item. A high bid is a bid that is equals or exceed the seller's predetermined ask amount. In step 21, the high bid is received, and in step 22, the facilitator determines that the bid is a high bid. In this situation, the bidder's high bid is automatically accepted by the facilitator on behalf of the seller and the information is routed for payment processing. In step 23, the facilitator attempts to use the payment information provided by the bidder to complete the sale. This would often take the form of having the facilitator 10 seek to charge an amount to a bidder's credit card. In step 24, the processing of the payment information of the bidder was unsuccessful (for example, the credit card is declined because the credit card number given is incorrect or the credit limit would be exceeded by the charge the facilitator is attempting to place on the card). The facilitator's databases would be updated, and in step 25, the negative result would be sent to the bidder. In step 26, the bid is rejected. In certain preferred embodiments the seller 20 may be unaware of any bids until processing and approval of the payment information of the bidder. Steps 25 and 26 constitute rejection steps 99, which facilitator follows whenever rejection is appropriate.

Turning now to approval steps 98, to help protect the buyer and seller, and/or to account for any necessary legal restrictions in the transfer of the item to be sold, the facilitator 10 can set up a safe keeping account seen in step 27, holding a payment from the bidder for a closed sale until completion of an additional event. When the additional event is completed, the facilitator can then release the payment to the seller, for example, in the form of a check to be mailed to the seller's address (provided as part of the seller's identification information.) Such an additional event could be, for example, the buyer taking possession of the item; the buyer contacting the facilitator to indicate that the item is in satisfactory condition, or a third party necessary to complete a legal transaction authorizing that the buyer has standing to take possession of the item.

At step 28 of FIG. 2 the payment information is processed properly and all facilitator databases are updated accordingly. In step 29, the facilitator 10 updates all related databases with information based on the approval of the bidder's payment information. At step 31, the bidder and seller account pages are updated. For the buyer, this can comprise, for example, an indication that the buyer's credit card has been charged. For the seller's account page, this can comprise, for example, a statement showing acknowledgment of the gross payment from the bidder minus a success fee to be paid by the seller to the facilitator upon closing of a sale, a check fee and a merchant fee for the credit card, as well as any other miscellaneous expenses or taxes. The seller's account page can also show a shipping address supplied by the buyer. Such a shipping address would preferably be a necessary portion of the identification information to be supplied by any bidder prior to bidding. For both the bidder and seller account pages, a reference transaction number may also be included to help in record keeping and tracking of the sale. An account page can also record and display details of the history of all bids and transactions made by a given buyer/bidder or seller. Preferably the account page would be where the bidders make bids and check the status of the bids submitted and where the sellers accept submitted bid offers and make counter bid offers. In step 32, confirming e-mails may be sent to both the buyer and seller, and any other necessary and pre-identified third party intermediary to confirm the sale of the item.

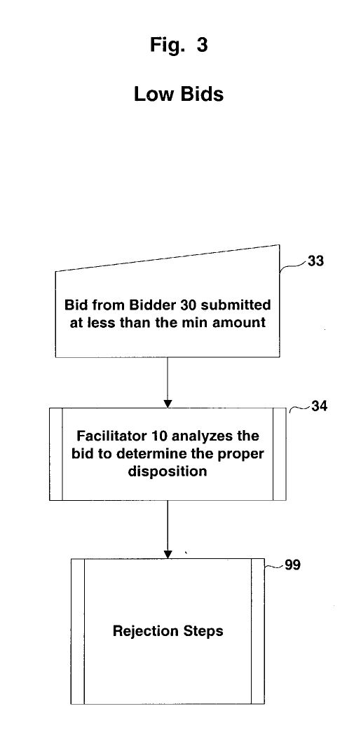

FIG. 3 shows a straightforward procedure when a low bid is received (step 33). A low bid is a bid below the seller's prespecified reserve or minimum amount. In step 34, the facilitator analyzes the bid and determines that it is a low bid. Such a bid is rejected and the facilitator follows rejection steps 99 analogous to those steps followed for a bid where payment information is rejected. Preferably the bidder would not be made aware of the minimum amount predetermined by the seller. The bidder would be free to submit another bid.

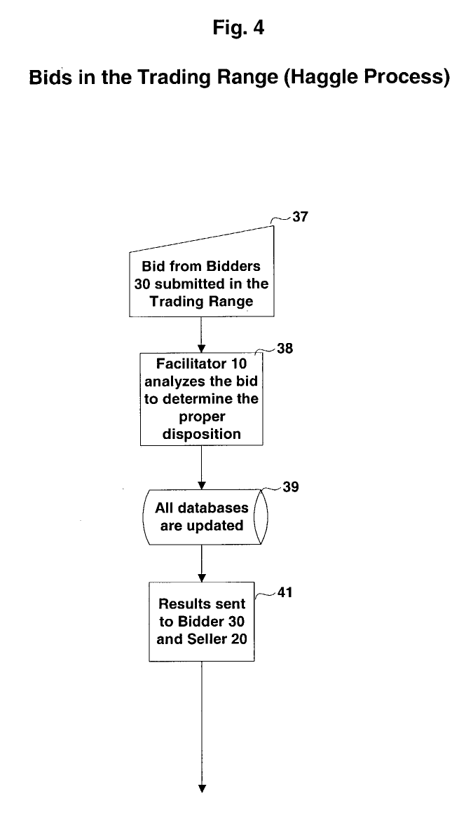

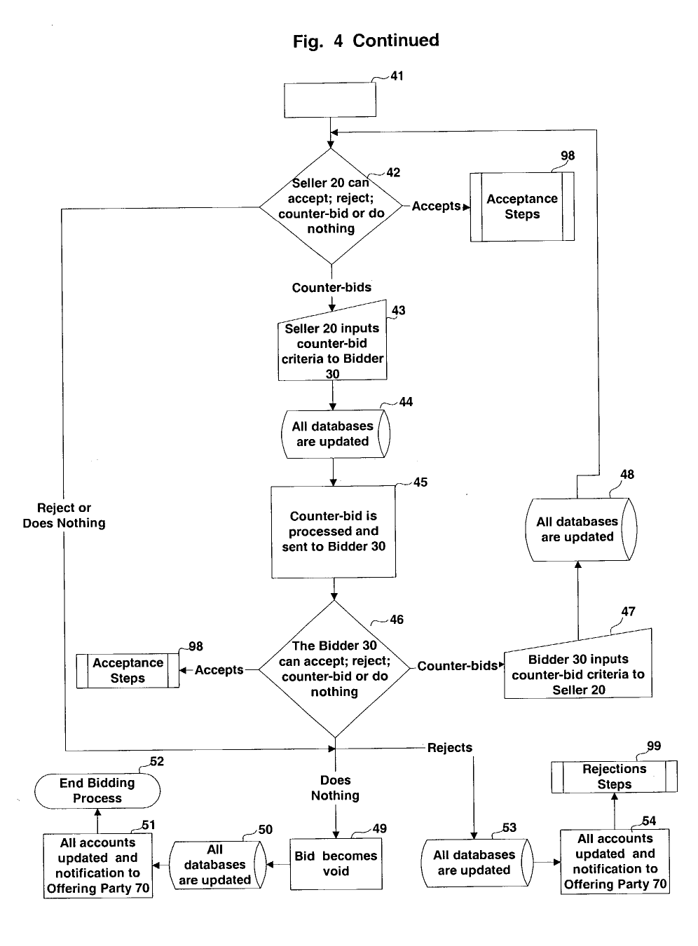

In accordance with a highly advantageous feature, the bidder's payment is automatically made upon completion of an accepted bid, either through submission of a high bid as discussed above, or through acceptance of a bid, a partial bid or counter bid as discussed below and outlined in FIG. 4.

Step 37 shows receipt by the facilitator of a bid which falls in the trading or haggle range. In step 38 the facilitator analyzes the bid to determine its proper disposition and in step 39 all pertinent databases are updated in a manner analogous to the process for receiving high bids and low bids. The results are then sent to the bidder 30 and seller 20 in Step 41, in the form of a message on their respective account screens, e-mail, etc. In accordance with a highly advantageous feature, at step 42 the seller 20 can, upon receipt of a bid, either accept the bid, reject the bid, do nothing with the bid (a form of rejection) or make a counter bid. If the seller chooses to accept the bid, the acceptance steps 98 are followed as before (subject to approval of payment information, as in the case of high bids). If the seller rejects the bid, then the databases are updated (step 53), the accounts created by the facilitator for the seller and for the bidder (whichever made is the offering party 70) are updated (step 54) and the rejection steps 99 are followed as before. If the seller does nothing, then after a predetermined period of time (step 49) the bid becomes stale or void (rejected) and all databases are updated (step 50). All accounts are updated and the offering party is notified (step 51) and the bidding process ends (step 52).

Counter bids are shown in step 45 where the seller 20 may input counter bid criteria (such as a different price) to the facilitator. This information would be incorporated into the facilitator's databases (step 46) and the counter bid would then be processed and sent to the bidder 30 (step 47). Once a counter bid has been sent to the bidder, then the bidder has much the same options as the seller had at step 42: the bidder can accept the counter bid (step 98), reject the counter bid (steps 53, 54, and 99), do nothing with the counter bid (steps 49-52) or, continue the process of haggling by submitting another bid (step 47). With continued haggling the facilitator's databases must be updated (step 48) and the process forms a loop with the seller presented with the same series of choices in response to the new bid by the bidder (step 42). This loop between the seller and the bidder continues until acceptance of a bid or counter bid, rejection, or the bid or counter bid becomes stale.

In accordance with a highly advantageous feature, the seller 20 can receive essentially simultaneously bids from multiple bidders. Moreover, the seller preferably sees all of the bids but each bidder only sees it's own bid. In this way, the bidders are not competing against one another directly, thereby avoiding some of the problems associated with buyer's remorse. In accordance with another highly advantageous feature, the seller can make counter bids unique to each individual bidder, and can accept any bid from any bidder, even if the bid is lower than a bid from another bidder. The facilitator preferably does not negotiate with either the seller or the buyer over the price of an item. Rather, the seller negotiates directly with the bidders.

In accordance with another highly advantageous feature, the item for sale may be a plurality or lot of items, and the bidder can be permitted to bid on all of the lot of items, or on only a portion of the lot of items, or on more than the lot of items, and is free to change the bid amount. Further, the seller can make a counter bid responsive to the bidders bid for a portion of the lot of items, or can make a counter bid to the bidder for a second portion of the lot of items different from the portion of the lot of items bid by the bidder. For example, a bidder may offer to bid for more items at a reduced price. Therefore, in much the same was as when haggling over a single item, negotiations over a lot of items can continue between the seller and the bidder indefinitely, or until a predetermined window of time has expired.

From the foregoing disclosure and detailed description of certain preferred embodiments, it will be apparent that various modifications, additions and other alternative embodiments are possible without departing from the true scope and spirit of the invention. The embodiments discussed were chosen and described to provide the best illustration of the principles of the invention and its practical application to thereby enable one of ordinary skill in the art to utilize the invention in various embodiments and with various modifications as are suited to the particular use contemplated. All such modifications and variations are within the scope of the invention as determined by the appended claims when interpreted in accordance with the breadth to which they are fairly, legally, and equitably entitled.

What is claimed is:

1. A method of selling an item using a computer and a communications network comprising in combination, the steps of:
registering a seller of the item to be sold and registering a bidder with a facilitator;
listing the item to be sold with the facilitator; and
specifying an ask amount and a minimum amount, wherein a trading zone is defined as a range between the minimum amount and the ask amount;
wherein when the bidder makes a high bid at a price which equals or exceeds the ask amount, the high bid is automatically accepted;
wherein when the bidder makes a low bid at a price which is less than the minimum amount, the facilitator automatically rejects the bidder's low bid; and
wherein when the bidder makes a bid at a price which is greater than or equal to the minimum amount and less than the ask amount, the seller is capable of choosing to accept the bid, to reject the bid, or to make a counter-offer to the bid.

2. The method of selling the item of claim 1 wherein the seller is capable of withdrawing the item from sale at any time prior to submission of a bid at a price acceptable to the seller.

3. The method of selling the item of claim 1 further comprising the step of:
closing the sale of the item upon successful processing of payment information and identification information.

4. The method of selling the item of claim 3 wherein payment information comprises a credit card number of a credit card account, and identification information comprises a shipping address to ship the item to.

5. The method of selling the item of claim 1 further comprising the step of:
allowing the bid to expire after a period of time, wherein the period of time is determined by one of the facilitator and the seller.

6. The method of selling the item of claim 1 wherein in response to an accepted bid the facilitator refuses any other bids from other bidders.

7. The method of selling the item of claim 1 wherein the seller pays the facilitator a success fee upon successful closing of the sale of the item.

8. The method of selling the item of claim 1 wherein the facilitator comprises a networked web site where both the seller and the bidder can register.

9. The method of selling the item of claim 1 further comprising the step of:
having the facilitator provide for a safe keeping account, holding a payment from the bidder to the seller until completion of an additional event, and upon completion of the additional event, releasing the payment to the seller.

10. A method of selling an item using a computer and a communications network comprising in combination, the steps of:
registering a seller of the item to be sold and a plurality of bidders with a facilitator; and
listing the item to be sold with the facilitator;
wherein the seller is capable of receiving essentially simultaneously a plurality of bids each corresponding to a separate bidder, and the facilitator does not reveal the bid of any bidder to any other bidder.

11. The method of selling the item of claim 10 wherein the facilitator does not reveal to any bidder how many other bidders are bidding on the item.

12. The method of selling the item of claim 10 wherein the seller can choose which of the plurality of bids to accept, if any, and can make a counter bid to any of the plurality of bidders.

13. The method of selling the item of claim 12 wherein in the event that one of the plurality of bidders makes a bid which meets or exceeds a predetermined amount set by the seller, then the seller automatically accepts that bidder's bid, and any other bids and counter bids are rejected.

14. The method of selling the item of claim 10 wherein the seller registers by providing identification information and payment information.

15. The method of selling the item of claim 10 wherein the bidder registers by providing identification information and payment information.

16. The method of selling the item of claim 10 wherein acceptance by the seller of one of the plurality of bids rejects the other of the plurality of bids and automatically ends all additional bidding on the item.

17. A method of selling an item using a computer and a communications network comprising in combination, the steps of:
registering a seller of the item to be sold and registering a bidder with a facilitator;
wherein the bidder is only able to bid on the item to be sold upon providing payment information to the facilitator;
listing the item to be sold with the facilitator; and
permitting the bidder to bid directly with the seller;
wherein the item can comprise a lot of items, and the bidder is capable of bidding at least one of a portion of the lot of items, and more than the lot of items.

18. A method of selling an item using a computer and a communications network comprising in combination, the steps of:
registering a seller of the item to be sold and registering a bidder with a facilitator;
wherein the bidder is only able to bid on the item to be sold upon providing payment information to the facilitator; and
listing the item to be sold with the facilitator;
wherein the seller is capable of receiving a bid from the bidder and is capable of sending a counter bid to the bidder.

19. The method of selling an item of claim 18 wherein the registration of the seller comprises the seller providing the facilitator with payment information.

20. The method of claim 18 wherein upon acceptance of the bid by the seller or acceptance of a counter bid by the bidder, the bidder's payment information is processed and, if approved, the facilitator will send a message informing both the bidder and the seller of the approval of the bidder's payment information.
